(19) United States
(12) Patent Application Publication
(10) Pub. No.: US 2026/0245297 A1
(43) Pub. Date: Aug. 20, 2026

(54) LIGHTING A MIXED-REALITY SCENE USING A VIRTUAL LIGHT SOURCE

(71) Applicant: Meta Platforms Technologies, LLC, Menlo Park, CA (US)

(72) Inventors: Jun Miao, San Jose, CA (US); Chuong Nguyen, San Jose, CA (US); Alex Dongseok Shin, Brea, CA (US)

(21) Appl. No.: 19/056,515

(22) Filed: Feb. 18, 2025

(51) Int. Cl. G06T 15/50; G06F 3/01

(52) U.S. Cl. CPC G06T 15/506; G06F 3/013; G06T 2210/36

(57) ABSTRACT

An embodiment includes training, using a training dataset, a scene relighting model to incorporate an effect of a virtual light source on a mixed-reality scene, the training resulting in a trained scene relighting model. An embodiment includes generating, from first color data and first depth data of a first frame of a mixed-reality scene and data of a first virtual light source, using the trained scene relighting model, a second frame corresponding to the first frame, the second frame incorporating an effect of the first virtual light source on the mixed-reality scene.

### TECHNICAL FIELD

The present disclosure generally relates to mixed reality, and more particularly to lighting a mixed-reality scene using a virtual light source.

### BACKGROUND

The term “mixed reality”, “mixed-reality”, or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real world. For example, an AR headset could be shaped as a pair of glasses with a pass-through display, which allows light from the real world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

An MR scene is typically a mixture of a real-world scene, portrayed in a passthrough manner (i.e., as if the user were seeing the scene through his or her own eyes rather than via a headset the user is wearing) and VR content such as a virtual object (e.g., a magic wand when the MR scene is part of a fantasy game). In MR, virtual objects are typically portrayed as lit by ambient light from the physical world, requiring lighting map estimation based on the passthrough camera scene. However, for verisimilitude, a virtual light source should also affect the real-world portion of a scene in a realistic looking manner, and this behavior is not currently available. For example, a virtual lamp situated on a physical table should appear to cast light onto the physical table. As another example, a virtual galaxy rendered in a cool color temperature does not harmonize well, and thus looks artificial, when projected into a physical room lit by lights in a warm color temperature. As a third example, blue light from a physical light source and red light from a virtual light source in a scene should combine realistically. Additionally, a virtual light source's failure to affect a physical portion of an MR scene becomes more obvious the darker the physical portion is.

Thus, there is a need to incorporate an effect of a virtual light source on the physical portion of a mixed-reality scene when rendering the mixed-reality scene.

### SUMMARY

Some embodiments of the present disclosure provide a computer-implemented method for lighting a mixed-reality scene using a virtual light source. The method includes training, using a training dataset, a scene relighting model to incorporate an effect of a virtual light source on a mixed-reality scene, the training resulting in a trained scene relighting model; and generating, from first color data and first depth data of a first frame of a mixed-reality scene and data of a first virtual light source, using the trained scene relighting model, a second frame corresponding to the first frame, the second frame incorporating an effect of the first virtual light source on the mixed-reality scene.

Some embodiments of the present disclosure provide a non-transitory computer-readable medium storing a program for lighting a mixed-reality scene using a virtual light source. The program, when executed by a computer, configures the computer to train, using a training dataset, a scene relighting model to incorporate an effect of a virtual light source on a mixed-reality scene, the training resulting in a trained scene relighting model; and generate, from first color data and first depth data of a first frame of a mixed-reality scene and data of a first virtual light source, using the trained scene relighting model, a second frame corresponding to the first frame, the second frame incorporating an effect of the first virtual light source on the mixed-reality scene.

Some embodiments of the present disclosure provide a system for lighting a mixed-reality scene using a virtual light source. The system comprises a processor and a non-transitory computer-readable medium storing a set of instructions, which when executed by the processor, configure the processor to train, using a training dataset, a scene relighting model to incorporate an effect of a virtual light source on a mixed-reality scene, the training resulting in a trained scene relighting model; and generate, from first color data and first depth data of a first frame of a mixed-reality scene and data of a first virtual light source, using the trained scene relighting model, a second frame corresponding to the first frame, the second frame incorporating an effect of the first virtual light source on the mixed-reality scene.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement lighting a mixed-reality scene using a virtual light source, according to some embodiments.

FIG. 2 is a block diagram illustrating details of a system for lighting a mixed-reality scene using a virtual light source, according to some embodiments.

FIG. 3 depicts a block diagram of an example configuration for lighting a mixed-reality scene using a virtual light source, in accordance with an illustrative embodiment.

FIG. 4 depicts an example of lighting a mixed-reality scene using a virtual light source, in accordance with an illustrative embodiment.

FIG. 5 depicts a continued example of lighting a mixed-reality scene using a virtual light source, in accordance with an illustrative embodiment.

FIG. 6 depicts another continued example of lighting a mixed-reality scene using a virtual light source, in accordance with an illustrative embodiment.

FIG. 7 depicts a flowchart of an example process for lighting a mixed-reality scene using a virtual light source, in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure address the above identified problems by implementing lighting a mixed-reality scene using a virtual light source. In particular, an embodiment trains, using a training dataset, a scene relighting model to incorporate an effect of a virtual light source on a mixed-reality scene; and generates, from first color data and first depth data of a first frame of a mixed-reality scene and data of a first virtual light source, using the trained scene relighting model, a second frame corresponding to the first frame, the second frame incorporating an effect of the first virtual light source on the mixed-reality scene.

Using a training dataset and a presently available machine learning technique, an embodiment trains a scene relighting model to incorporate an effect of a particular virtual light source on a given mixed-reality scene. In some embodiments, the scene relighting model is implemented using an artificial neural network and trained using a presently available neural network training technique. The training dataset includes pairs of image frames, with each pair of frames including an original image frame of a training mixed-reality scene and a relit frame of the same scene incorporating an effect of the virtual light source on the scene. One embodiment starts with three-dimensional data of a real-world scene and data of a particular virtual light source. The embodiment generates the training dataset by using a presently available rendering tool to generate three-dimensional data of the same scene lit by the virtual light source in various positions within the scene and extracts corresponding image frames from the original and rendered scenes. Data of a particular virtual light source includes, for example, a size, shape, color temperature, color temperature distribution, and the like.

One embodiment maintains a library of virtual light sources, where each entry in the library includes data of a virtual light source and a trained scene relighting model that is usable to incorporate an effect of the virtual light source on an input mixed-reality scene. For example, a library of virtual light sources for use in an MR room decorating application might include data of one or virtual desk lamps, table lamps, floor lamps, and ceiling lights that could be rendered in the application. As another example, a library of virtual light sources for use in an MR fantasy game might include data of a magic wand, a glowing orb, and other visual effects that could be rendered in the application.

Using data of a specific virtual light source, including a trained scene relighting model specific to the virtual light source and a position of the virtual light source within a mixed-reality scene, an embodiment generates, from color data and depth data of an input frame of the mixed-reality scene, a corresponding output frame. The output frame incorporates an effect of the specific virtual light source on the mixed-reality scene. When data of a gaze position of a user viewing the mixed-reality scene is available, some embodiments render the output frame as a foveated rendering, in which one portion of the second frame (e.g., a peripheral portion) is rendered at a first level of detail and a second portion of the output frame (e.g., a central portion surrounded by the peripheral portion) is rendered at a second level of detail higher than the first level of detail. An embodiment selects the two portions based on a gaze position of a user viewing the mixed-reality scene. Human users'central vision is higher resolution than their peripheral vision, and thus foveated rendering improves overall scene rendering speed by rendering at a level of detail appropriate to what a user perceives. An embodiment calculates a user's gaze position from MR headset sensor data, such as inertial measurement unit sensor data measuring a user's head movement, camera data measuring movements of a user's eyes, gesture sensor data measuring movements of a user's head, arm, finger, or other body part, and the like.

As a user experiences a typical MR scene, elements of the scene often do not change much from one input image frame to another within a video stream depicting the MR scene. For example, a user might be looking around or navigating through a scene including stationary objects (both physical and virtual), and at sixty frames per second (a typical video frame rate) the perceived positions and effects of the stationary objects will not differ much from one frame to the next. Thus, an embodiment need not use a trained scene relighting model to relight every video frame in a sequence of frames. In fact, using the trained scene relighting model on every frame might introduce undesirable visual inconsistencies between frames. Instead, an embodiment determines, after having used the trained scene relighting model on data of a first frame, from color data and depth data of a subsequent input frame of a mixed-reality scene and from data of the virtual light source, that the subsequent input frame meets a criterion for using a different model instead of the trained scene relighting model. The different model is a less complex model than the scene relighting model, requiring fewer computations (providing faster rendering and maintaining the real-time nature of the rendering) and less power (providing improved battery life) than if the scene relighting model were used on every frame.

One non-limiting example of a criterion for using a different model is a change between the image data, depth data, or both of a first frame and a subsequent frame that is less than a threshold amount of change. Once a different model has been used, an embodiment determines whether to continue to use the different model or switch back to using the trained scene relighting model. Some non-limiting examples of a criterion for using the trained scene relighting model are receipt of a signal that the scene has changed more than a threshold amount (e.g., because the user has moved to a different MR room or a different location within a game), an elapsed time or number of subsequent frames received that is higher than a threshold, and use of a different virtual light source or a different setting for the original virtual light source. Other criteria for switching between models are also possible and contemplated within the scope of the illustrative embodiments.

One example of a different model is a trained propagation model. In particular, an embodiment, using a training dataset described elsewhere herein, trains a propagation model to propagate an effect of a virtual light source from a relit frame to a subsequent frame of a mixed-reality scene. In some embodiments, the propagation model is implemented using an artificial neural network and trained using a presently available neural network training technique. The scene relighting model and the propagation model need not be implemented using the same artificial neural network architecture or trained using the same training technique. Using data of the same virtual light source as was used to generate a previous relit frame using a trained scene relighting model, including a current position of the virtual light source within a mixed-reality scene, an embodiment uses a trained propagation model to generate, from the relit frame and color data and depth data of a subsequent frame of the mixed-reality scene, a corresponding output frame. The corresponding output frame incorporates the effect of the first virtual light source on the mixed-reality scene. When data of a gaze position of a user viewing the mixed-reality scene is available, some embodiments render the output frame as a foveated rendering, based on a gaze position of a user viewing the mixed-reality scene, in a manner described elsewhere herein.

Another example of a different model is a color mixture model. In particular, an embodiment determines, from the data of the first virtual light source, that a light distribution of a virtual light source being modelled meets a color mixture model usage criterion. One example of a color mixture model usage criterion is a uniformity of light distribution of the first virtual light source in the mixed-reality scene that is above a threshold amount of uniformity. Thus, if the light from a virtual light source is sufficiently uniformly distributed within an MR scene, shadows and a spatial distribution of the light will not change as a user experiences the scene. As a result, an embodiment need not use a trained propagation model. Instead, an embodiment uses a color mixture model to mix source color from the virtual light source and background color already present in the scene. In embodiments, the color mixture model is implemented using a weighted average, a color superposition calculation, or another presently available color mixture method. Using data of the same virtual light source as was used to generate a previous relit frame using a trained scene relighting model, an embodiment uses a color mixture model to generate, from the relit frame and color data and depth data of a subsequent frame of the mixed-reality scene, a corresponding output frame. The corresponding output frame incorporates the effect of the first virtual light source on the mixed-reality scene. When data of a gaze position of a user viewing the mixed-reality scene is available, some embodiments render the output frame as a foveated rendering, based on a gaze position of a user viewing the mixed-reality scene, in a manner described elsewhere herein.

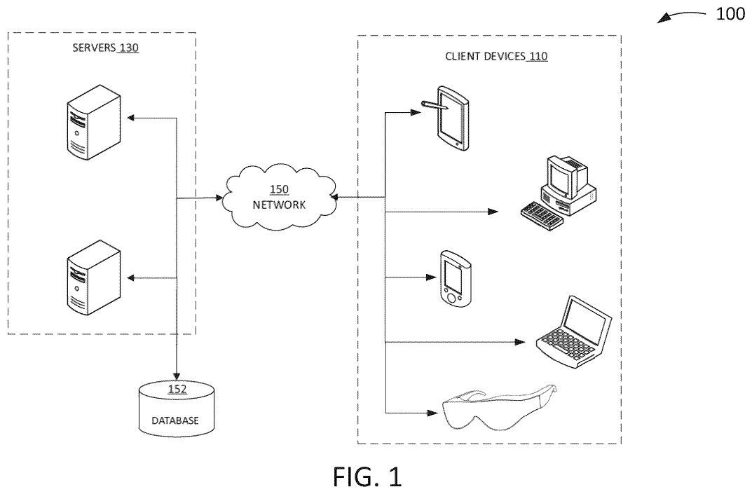

FIG. 1 illustrates a network architecture 100 used to implement lighting a mixed-reality scene using a virtual light source, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

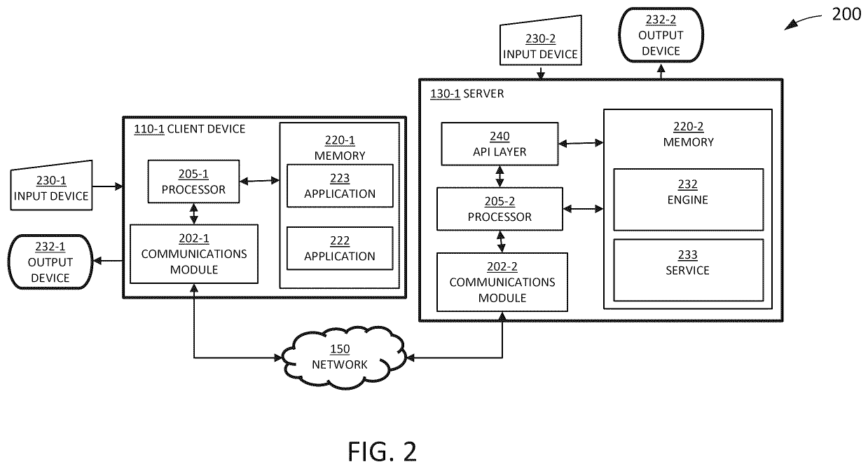

FIG. 2 is a block diagram illustrating details of a system 200 for lighting a mixed-reality scene using a virtual light source, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement lighting a mixed-reality scene using a virtual light source. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide lighting a mixed-reality scene using a virtual light source. The application 223 may communicate with service 233 through API layer 240, for example.

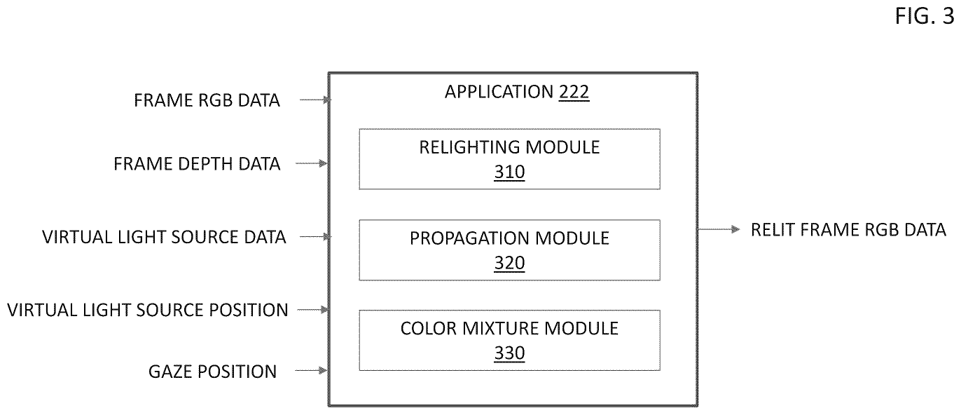

FIG. 3 depicts a block diagram of an example configuration for lighting a mixed-reality scene using a virtual light source, in accordance with an illustrative embodiment. Application 222 is the same as application 222 in FIG. 2.

Using a training dataset and a presently available machine learning technique, relighting module 310 trains a scene relighting model to incorporate an effect of a particular virtual light source on a given mixed-reality scene. In some implementations of module 310, the scene relighting model is implemented using an artificial neural network and trained using a presently available neural network training technique. The training dataset includes pairs of image frames, with each pair of frames including an original image frame of a training mixed-reality scene and a relit frame of the same scene incorporating an effect of the virtual light source on the scene. One implementation of module 310 starts with three-dimensional data of a real-world scene and data of a particular virtual light source. The implementation generates the training dataset by using a presently available rendering tool to generate three-dimensional data of the same scene lit by the virtual light source in various positions within the scene and extracts corresponding image frames from the original and rendered scenes. Data of a particular virtual light source includes, for example, a size, shape, color temperature, color temperature distribution, and the like.

Application 222 maintains a library of virtual light sources, where each entry in the library includes data of a virtual light source and a trained scene relighting model that is usable to incorporate an effect of the virtual light source on an input mixed-reality scene. For example, a library of virtual light sources for use in an MR room decorating application might include data of one or virtual desk lamps, table lamps, floor lamps, and ceiling lights that could be rendered in the application. As another example, a library of virtual light sources for use in an MR fantasy game might include data of a magic wand, a glowing orb, and other visual effects that could be rendered in the application.

Using data of a specific virtual light source, including a trained scene relighting model specific to the virtual light source and a position of the virtual light source within a mixed-reality scene, module 310 generates, from color data and depth data of an input frame of the mixed-reality scene, a corresponding output frame. The output frame incorporates an effect of the specific virtual light source on the mixed-reality scene. When data of a gaze position of a user viewing the mixed-reality scene is available, some implementations of module 310 render the output frame as a foveated rendering, in which one portion of the second frame (e.g., a peripheral portion) is rendered at a first level of detail and a second portion of the output frame (e.g., a central portion surrounded by the peripheral portion) is rendered at a second level of detail higher than the first level of detail. Module 310 selects the two portions based on a gaze position of a user viewing the mixed-reality scene. Human users'central vision is higher resolution than their peripheral vision, and thus foveated rendering improves overall scene rendering speed by rendering at a level of detail appropriate to what a user perceives. An embodiment calculates a user's gaze position from MR headset sensor data, such as inertial measurement unit sensor data measuring a user's head movement, camera data measuring movements of a user's eyes, gesture sensor data measuring movements of a user's head, arm, finger, or other body part, and the like.

As a user experiences a typical MR scene, elements of the scene often do not change much from one input image frame to another within a video stream depicting the MR scene. For example, a user might be looking around or navigating through a scene including stationary objects (both physical and virtual), and at sixty frames per second (a typical video frame rate) the perceived positions and effects of the stationary objects will not differ much from one frame to the next. Thus, application 222 need not use a trained scene relighting model to relight every video frame in a sequence of frames. In fact, using the trained scene relighting model on every frame might introduce undesirable visual inconsistencies between frames. Instead, propagation module 320 determines, after the trained scene relighting model has been used on data of a first frame, from color data and depth data of a subsequent input frame of a mixed-reality scene and from data of the virtual light source, that the subsequent input frame meets a criterion for using a different model instead of the trained scene relighting model. The different model is a less complex model than the scene relighting model, requiring fewer computations (providing faster rendering and maintaining the real-time nature of the rendering) and less power (providing improved battery life) than if the scene relighting model were used on every frame.

One non-limiting example of a criterion for using a different model is a change between the image data, depth data, or both of a first frame and a subsequent frame that is less than a threshold amount of change. Once a different model has been used, module 320 determines whether to continue to use the different model or switch back to using the trained scene relighting model. Some non-limiting examples of a criterion for using the trained scene relighting model are receipt of a signal that the scene has changed more than a threshold amount (e.g., because the user has moved to a different MR room or a different location within a game), an elapsed time or number of subsequent frames received that is higher than a threshold, and use of a different virtual light source or a different setting for the original virtual light source. Other criteria for switching between models are also possible and contemplated within the scope of the illustrative embodiments.

One example of a different model is a trained propagation model. In particular, module 320, using a training dataset described elsewhere herein, trains a propagation model to propagate an effect of a virtual light source from a relit frame to a subsequent frame of a mixed-reality scene. In some implementations of module 320, the propagation model is implemented using an artificial neural network and trained using a presently available neural network training technique. The scene relighting model and the propagation model need not be implemented using the same artificial neural network architecture or trained using the same training technique. Using data of the same virtual light source as was used to generate a previous relit frame using a trained scene relighting model, including a current position of the virtual light source within a mixed-reality scene, module 320 uses a trained propagation model to generate, from the relit frame and color data and depth data of a subsequent frame of the mixed-reality scene, a corresponding output frame. The corresponding output frame incorporates the effect of the first virtual light source on the mixed-reality scene. When data of a gaze position of a user viewing the mixed-reality scene is available, some implementations of module 320 render the output frame as a foveated rendering, based on a gaze position of a user viewing the mixed-reality scene, in a manner described elsewhere herein.

Another example of a different model is a color mixture model. In particular, color mixture module 330 determines, from the data of the first virtual light source, that a light distribution of a virtual light source being modelled meets a color mixture model usage criterion. One example of a color mixture model usage criterion is a uniformity of light distribution of the first virtual light source in the mixed-reality scene that is above a threshold amount of uniformity. Thus, if the light from a virtual light source is sufficiently uniformly distributed within an MR scene, shadows and a spatial distribution of the light will not change as a user experiences the scene. As a result, a trained propagation model need not be used. Instead, color mixture module 330 uses a color mixture model to mix source color from the virtual light source and background color already present in the scene. In implementations of module 330, the color mixture model is implemented using a weighted average, a color superposition calculation, or another presently available color mixture method. Using data of the same virtual light source as was used to generate a previous relit frame using a trained scene relighting model, module 330 uses a color mixture model to generate, from the relit frame and color data and depth data of a subsequent frame of the mixed-reality scene, a corresponding output frame. The corresponding output frame incorporates the effect of the first virtual light source on the mixed-reality scene. When data of a gaze position of a user viewing the mixed-reality scene is available, some implementations of module 330 render the output frame as a foveated rendering, based on a gaze position of a user viewing the mixed-reality scene, in a manner described elsewhere herein.

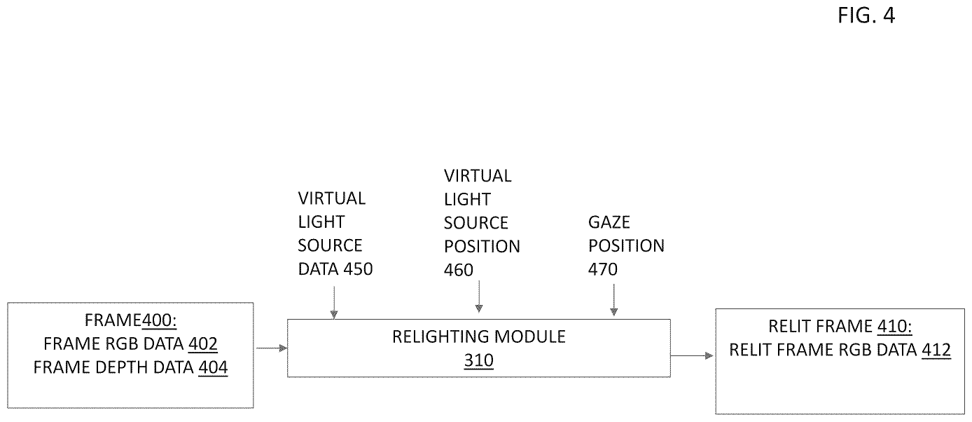

FIG. 4 depicts an example of lighting a mixed-reality scene using a virtual light source, in accordance with an illustrative embodiment. The example can be executed using application 222 in FIG. 2. Relighting module 310 is the same as relighting module 310 in FIG. 3.

Using virtual light source data 450, including a trained scene relighting model specific to the virtual light source, virtual light source position 460, and gaze position 470, module 310 generates, from input frame 400 (including frame red-green-blue (RGB) data 402 and frame depth data 404) of a mixed-reality scene, relit frame 410 including relit frame RGB data 412. Relit frame 410 incorporates an effect of the specific virtual light source on the mixed-reality scene.

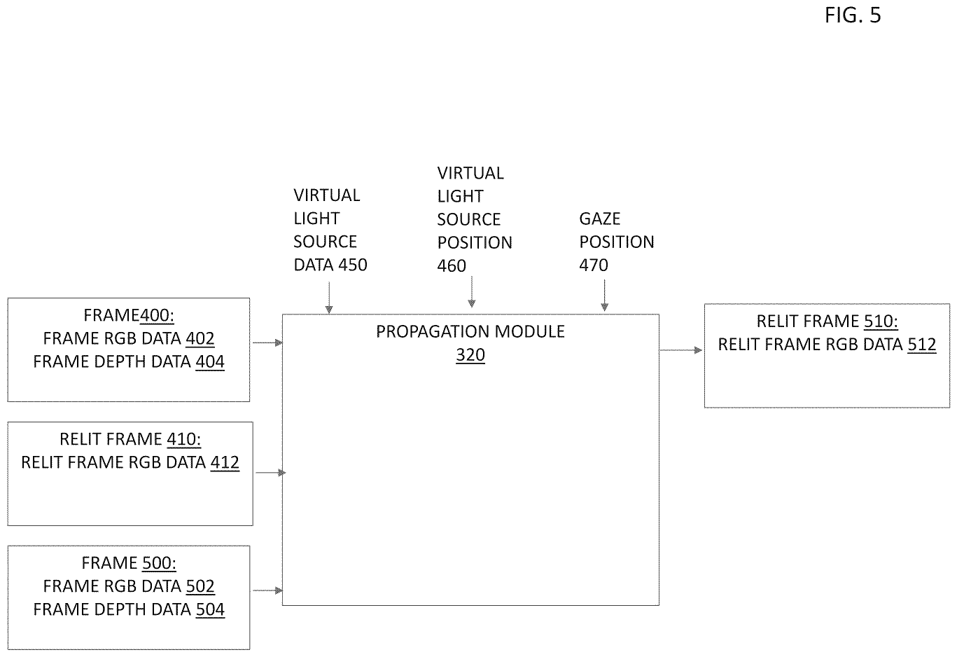

FIG. 5 depicts a continued example of lighting a mixed-reality scene using a virtual light source, in accordance with an illustrative embodiment. Propagation module 320 is the same as propagation module 320 in FIG. 3. Frame 400, frame RGB data 402, frame depth data 404, relit frame 410, relit frame RGB data 412, virtual light source data 450, virtual light source position 460, and gaze position 470 are the same as frame 400, frame RGB data 402, frame depth data 404, relit frame 410, relit frame RGB data 412, virtual light source data 450, virtual light source position 460, and gaze position 470 in FIG. 4.

Module 320 compares frame 400 and frame 500 (including frame RGB data 502 and frame depth data 504), and determines that frame 500, a frame subsequent to frame 400, meets a criterion for using a propagation model instead of a scene relighting module used to generate relit frame 410. Thus, using virtual light source data 450, virtual light source position 460, and gaze position 470, module 320 uses a trained propagation model to generate, from relit frame 410 and frame 500 (including frame RGB data 502 and frame depth data 504) of a mixed-reality scene, relit frame 510 including relit frame RGB data 512. Relit frame 510 incorporates an effect of the specific virtual light source on the mixed-reality scene.

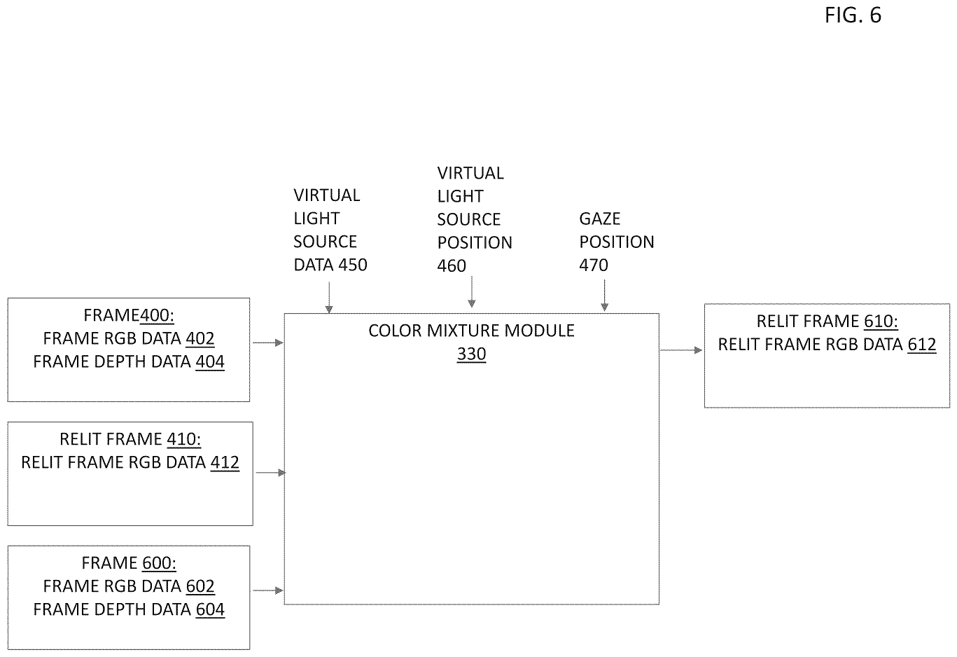

FIG. 6 depicts another continued example of lighting a mixed-reality scene using a virtual light source, in accordance with an illustrative embodiment. Color mixture module 330 is the same as color mixture module 330 in FIG. 3. Frame 400, frame RGB data 402, frame depth data 404, relit frame 410, relit frame RGB data 412, virtual light source data 450, virtual light source position 460, and gaze position 470 are the same as frame 400, frame RGB data 402, frame depth data 404, relit frame 410, relit frame RGB data 412, virtual light source data 450, virtual light source position 460, and gaze position 470 in FIG. 4.

Module 330 compares frame 400 and frame 600 (including frame RGB data 602 and frame depth data 604), and determines that frame 600, a frame subsequent to frame 400, meets a criterion for using a color mixture model instead of a scene relighting module used to generate relit frame 410. Thus, using virtual light source data 450, virtual light source position 460, and gaze position 470, module 330 uses a color mixture model to generate, from relit frame 410 and frame 600 (including frame RGB data 602 and frame depth data 604) of a mixed-reality scene, relit frame 610 including relit frame RGB data 612. Relit frame 610 incorporates an effect of the specific virtual light source on the mixed-reality scene.

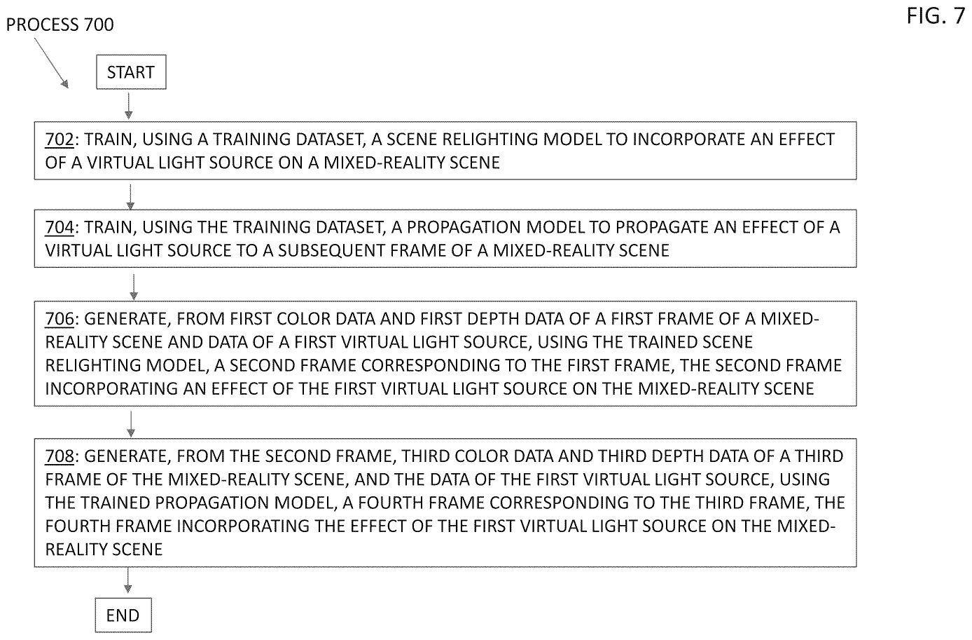

FIG. 7 depicts a flowchart of an example process for lighting a mixed-reality scene using a virtual light source, in accordance with an illustrative embodiment. Process 700 can be implemented in application 222 in FIG. 2.

At block 702, the process trains, using a training dataset, a scene relighting model to incorporate an effect of a virtual light source on a mixed-reality scene. At block 704, the process trains, using the training dataset, a propagation model to propagate an effect of a virtual light source to a subsequent frame of a mixed-reality scene. At block 706, the process generates, from first color data and first depth data of a first frame of a mixed-reality scene and data of a first virtual light source, using the trained scene relighting model, a second frame corresponding to the first frame, the second frame incorporating an effect of the first virtual light source on the mixed-reality scene. At block 708, the process generates, from the second frame, third color data and third depth data of a third frame of the mixed-reality scene, and the data of the first virtual light source, using the trained propagation model, a fourth frame corresponding to the third frame, the fourth frame incorporating the effect of the first virtual light source on the mixed-reality scene. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A computer-implemented method, comprising:
training, using a training dataset, a scene relighting model to incorporate an effect of a virtual light source on a mixed-reality scene, the training resulting in a trained scene relighting model; and
generating, from first color data and first depth data of a first frame of a mixed-reality scene and data of a first virtual light source, using the trained scene relighting model, a second frame corresponding to the first frame, the second frame incorporating an effect of the first virtual light source on the mixed-reality scene.

2. The computer-implemented method of claim 1, wherein a first portion of the second frame is rendered at a first level of detail and a second portion of the second frame is rendered at a second level of detail higher than the first level of detail, wherein the first portion and the second portion are selected based on a gaze position of a user viewing the mixed-reality scene.

3. The computer-implemented method of claim 1, wherein the training dataset comprises a plurality of pairs of frames, each pair of frames in the plurality of pairs of frames comprising an original frame of a training mixed-reality scene and a relit frame of the training mixed-reality scene incorporating an effect of a training virtual light source on the training mixed-reality scene.

4. The computer-implemented method of claim 1, further comprising:
training, using the training dataset, a propagation model to propagate an effect of a virtual light source to a subsequent frame of a mixed-reality scene, the training resulting in a trained propagation model.

5. The computer-implemented method of claim 4, further comprising:
generating, from the second frame, third color data and third depth data of a third frame of the mixed-reality scene, and the data of the first virtual light source, using the trained propagation model, a fourth frame corresponding to the third frame, the fourth frame incorporating the effect of the first virtual light source on the mixed-reality scene.

6. The computer-implemented method of claim 1, further comprising:
generating, from the second frame, fifth color data and fifth depth data of a fifth frame of the mixed-reality scene, and the data of the first virtual light source, using a color mixture model, a sixth frame corresponding to the fifth frame, the sixth frame incorporating the effect of the first virtual light source on the mixed-reality scene.

7. The computer-implemented method of claim 6, wherein the sixth frame is generated using the color mixture model responsive to determining, from the data of the first virtual light source, that a light distribution of the first virtual light source meets a color mixture model usage criterion.

8. The computer-implemented method of claim 7, wherein the color mixture model usage criterion comprises a uniformity of light distribution of the first virtual light source in the mixed-reality scene above a threshold amount of uniformity.

9. A non-transitory computer-readable medium storing a program, which when executed by a computer, configures the computer to:
train, using a training dataset, a scene relighting model to incorporate an effect of a virtual light source on a mixed-reality scene, the training resulting in a trained scene relighting model; and
generate, from first color data and first depth data of a first frame of a mixed-reality scene and data of a first virtual light source, using the trained scene relighting model, a second frame corresponding to the first frame, the second frame incorporating an effect of the first virtual light source on the mixed-reality scene.

10. The non-transitory computer-readable medium of claim 9, wherein a first portion of the second frame is rendered at a first level of detail and a second portion of the second frame is rendered at a second level of detail higher than the first level of detail, wherein the first portion and the second portion are selected based on a gaze position of a user viewing the mixed-reality scene.

11. The non-transitory computer-readable medium of claim 9, wherein the training dataset comprises a plurality of pairs of frames, each pair of frames in the plurality of pairs of frames comprising an original frame of a training mixed-reality scene and a relit frame of the training mixed-reality scene incorporating an effect of a training virtual light source on the training mixed-reality scene.

12. The non-transitory computer-readable medium of claim 9, wherein the program, when executed by the computer, further configures the computer to:
train, using the training dataset, a propagation model to propagate an effect of a virtual light source to a subsequent frame of a mixed-reality scene, the training resulting in a trained propagation model.

13. The non-transitory computer-readable medium of claim 12, wherein the program, when executed by the computer, further configures the computer to:
generate, from the second frame, third color data and third depth data of a third frame of the mixed-reality scene, and the data of the first virtual light source, using the trained propagation model, a fourth frame corresponding to the third frame, the fourth frame incorporating the effect of the first virtual light source on the mixed-reality scene.

14. The non-transitory computer-readable medium of claim 9, wherein the program, when executed by the computer, further configures the computer to:
generate, from the second frame, fifth color data and fifth depth data of a fifth frame of the mixed-reality scene, and the data of the first virtual light source, using a color mixture model, a sixth frame corresponding to the fifth frame, the sixth frame incorporating the effect of the first virtual light source on the mixed-reality scene.

15. The non-transitory computer-readable medium of claim 14, wherein the sixth frame is generated using the color mixture model responsive to determining, from the data of the first virtual light source, that a light distribution of the first virtual light source meets a color mixture model usage criterion.

16. The non-transitory computer-readable medium of claim 15, wherein the color mixture model usage criterion comprises a uniformity of light distribution of the first virtual light source in the mixed-reality scene above a threshold amount of uniformity.

17. A system, comprising:
a processor; and
a non-transitory computer-readable medium storing a set of instructions, which when executed by the processor, configure the system to:
train, using a training dataset, a scene relighting model to incorporate an effect of a virtual light source on a mixed-reality scene, the training resulting in a trained scene relighting model; and
generate, from first color data and first depth data of a first frame of a mixed-reality scene and data of a first virtual light source, using the trained scene relighting model, a second frame corresponding to the first frame, the second frame incorporating an effect of the first virtual light source on the mixed-reality scene.

18. The system of claim 17, wherein a first portion of the second frame is rendered at a first level of detail and a second portion of the second frame is rendered at a second level of detail higher than the first level of detail, wherein the first portion and the second portion are selected based on a gaze position of a user viewing the mixed-reality scene.

19. The system of claim 17, wherein the training dataset comprises a plurality of pairs of frames, each pair of frames in the plurality of pairs of frames comprising an original frame of a training mixed-reality scene and a relit frame of the training mixed-reality scene incorporating an effect of a training virtual light source on the training mixed-reality scene.

20. The system of claim 17, wherein the instructions, when executed by the processor, further configure the system to:
train, using the training dataset, a propagation model to propagate an effect of a virtual light source to a subsequent frame of a mixed-reality scene, the training resulting in a trained propagation model.
